(19) United States
(12) Patent Application Publication
(10) Pub. No.: US 2007/0137774 A1
(43) Pub. Date: Jun. 21, 2007

(54) Laminating by means of an embossing device

(75) Inventor: Jurgen Scholzig, Mainz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MAN Roland Druckmaschinen AG, Offenbach (DE)

(21) Appl. No.: 11/639,774

(22) Filed: Dec. 15, 2006

(30) Foreign Application Priority Data
Dec. 17, 2005 (DE) 102005060589.3

(51) Int. Cl. B41M 5/03; B44C 1/17; B32B 37/12; B32B 38/14; B65C 9/46

(52) U.S. Cl. 156/235; 156/241; 156/277; 156/578; 156/387; 156/540; 156/547

(57) ABSTRACT

A coating unit for transferring image-imparting or covering layers from a transfer film to a printing material that can be used for the production of complex printing materials is provided. The device of the present invention includes at least one film application module FA in a sheet-fed rotary printing press. The film application module is useable in a variety of combinations with printing units, varnishing units and at least one turning device.

### FIELD OF THE INVENTION

The present invention relates to a method and a device for transferring image-imparting or covering layers from a carrier film to printing sheets.

### BACKGROUND OF THE INVENTION

Produce metallic layers on printing sheets using a foil or film transfer method is known. For example, a printing material and a printing device which uses the printing material are described in EP 0 569 520 B1. This reference discloses a sheet-processing machine is disclosed that has printing units, coating units, a feeder and a deliverer. A adhesive pattern is applied as the printing subject using a planographic printing method in at least one printing unit. The coating unit after the printing unit includes an impression cylinder, a press roll and a film guide. In the coating unit, a strip of film from a film supply roll is guided through a transfer nip between the impression cylinder and the press roll. The strip of film is rewound on the outlet side after leaving the coating unit. The transfer film includes a carrier film, on which functional layers of various types, such as metallic layers (e.g., aluminum) or plastic layers can be applied. A release layer is provided between the functional layer and carrier film is a release layer. The release layer ensures that the functional layer can be pulled off the carrier layer.

After a printing sheet has been provided with a two-dimensional application or pattern of adhesive, it is led through the coating unit. The printing sheet rests on the impression cylinder and is joined to the film material by the press roll. In the process, the functional layer located on the bottom of the film material is tightly pressed against the regions on the printing sheet provided with adhesive. As a result, the functional layer adheres only in the region of the adhesive patterns or full-area adhesive regions with the functional layer being removed from the carrier film in these areas. The printed sheet is output in the coated state.

Lamination or sealing with a film layer are known further production methods in graphics technology. From the periodical Flexo+Tief-Druck [Flexo-+Gravure-Print], vol. 2, 2005, in “Neue Trends bei kaschierten Verpackungen” [New trends in laminated packaging materials], it is known that expedient combinations of various materials having useful properties in a complex composite permit packaging material laminated in different ways to be produced. In a complex production process, knowledge about the substrate, ink system and adhesive and their interactions is necessary in order to eliminate the risks the can arise from wrongly processed laminated packaging materials. The referenced article reports on inks that can be laminated or barrier properties of coatings and on the defects in a production process.

The disadvantage with the described procedures is that they cannot be employed in a flexible manner, require extensive know-how of the complex processes and are difficult to handle.

### BRIEF SUMMARY OF THE INVENTION

In view of the foregoing, a general object of the present invention is to provide a method and a device with which the lamination of printing sheets can be carried out in a simple, reliable, economical and precise manner. A further object of the invention is to provide a method and device that are simple to handle.

The method of the present invention advantageously can be used to laminate one or both sides of functional packaging materials so as to provide, for example, barrier properties. A sheet-fed rotary printing press can be used to apply the coatings or lamination, which can be carried out by a cold film embossing method.

Application of film to one or both sides of the printing sheets is possible through the use of a combination of coating units (such as varnishing modules), a sheet turning device and film coating modules. The method and device of the present invention in conjunction with the printability of the printing material on both sides also enable the production of functional and decorative applications and composite film packaging materials.

The procedures that can be accomplished with the present invention include:
1. Two-sided coating of a printing material by a film application via cold film embossing method can be used to produce composite packaging materials, such as combinations of paper-aluminum-PET or PET-aluminum-PE or the like.
2. The processing of film and/or paper with vapor-deposited aluminum lamination, vapor-deposited aluminum papers or a barrier protection or the application of a further film layer can be performed using in-line printing or coating using a sheet-fed rotary printing press and a cold film embossing application for the production of composite packaging materials with one or more coating modules within a printing press. Thus, establishing the functional characteristics of the packaging material properties can be combined with the application of a decorative film.
3. In combination with the method steps for in-line printing, the production of composite packaging materials by processing film or paper of different qualities, a barrier protection or the application of a further film layer can be achieved, even after pre-coating, via in-line varnishing and in-line coating within a single sheet-fed rotary printing press having varnishing modules and one or more cold film embossing devices. It is therefore also possible for the establishment of the functional characteristics of the packaging material properties, a visual or tactile pre-coating and the application of a lamination or decorative film to be combined.
4. If appropriate, in the cold film embossing application, integration of the cold film embossing method may be suitable for general application for printing or coating both sides via the combination of printing, sheet turning, film application to the opposite side, (if appropriate) printing and varnishing.
5. The application of functional characteristics substantially increases the value of the packaging material products, in particular, as a result of the introduction of barrier properties with regard to water vapor, blackdamp aroma, smells, light protection, seal strength and barrier layers. In this case, film can be applied to both sides of the packaging materials in in-line and/or off-line operation in order to improve their barrier properties. The processing of aluminum-laminated printing materials is a further possibility through a cold film embossing application in a sheet-fed rotary or flexographic printing press.
6. The device of the present invention can include a coating module for the cold film embossing method before and/or after a turning device within a sheet-fed printing press. Such an arrangement can advantageously supplement the described process technology.

### BRIEF DESCRIPTION OF THE SEVERAL VIEWS OF THE DRAWINGS

FIG. 1 is a side view of an illustrative printing press having a film transfer device according to the present invention.

FIG. 2 is a schematic side view of a first configuration of a sheet-fed printing press having a coating unit according to the invention.

FIG. 3 is a schematic side view of a second configuration of a sheet-fed printing press having a coating unit according to the invention.

### DETAILED DESCRIPTION OF THE INVENTION

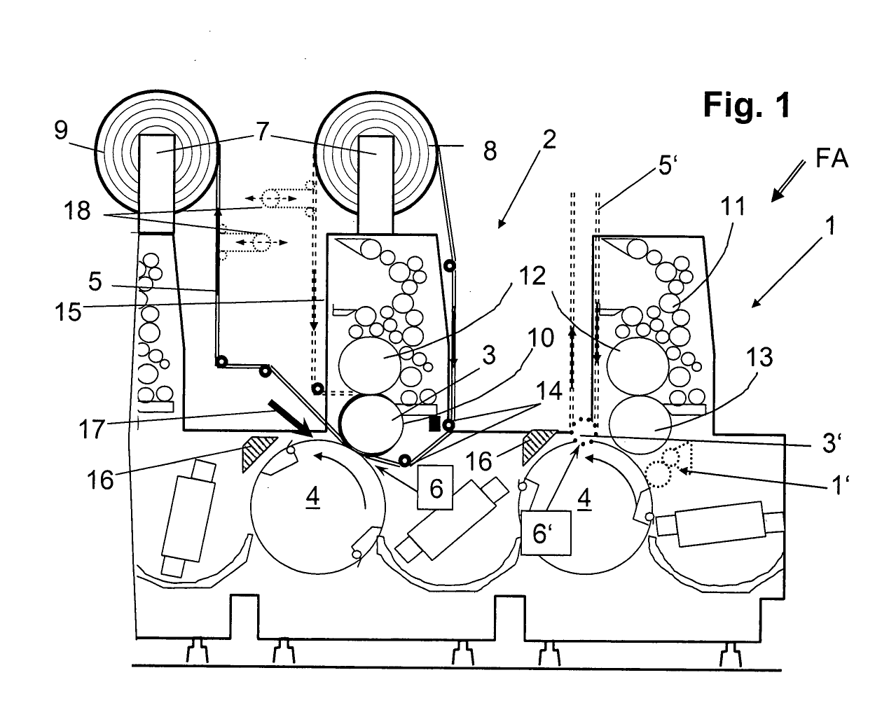

Referring to FIG. 1 of the drawings, parts of an exemplary sheet-fed rotary printing press which contains two printing units is shown. The illustrated printing press can be used to first provide a printing sheet with a two-dimensional or image-imparting adhesive pattern (printing unit as applicator 1). In the following printing unit, the printing sheet, together with a transfer film 5, is led through a transfer nip 6 under pressure (coating unit 2).

The transfer nip 6 in the coating unit 2 is formed by a press roll 3 and an impression cylinder 4. The press roll 3 can correspond to the blanket cylinder and the impression cylinder 4 to the impression cylinder of an offset printing unit. The press roll 3 can also correspond to the form cylinder and the impression cylinder 4 to the impression cylinder of a varnishing module. Within the coating unit 2 used for the film transfer, a web guidance system for transfer films is provided.

Alternatively, as shown in FIG. 1 in conjunction with the applicator 1, a film transfer device that is integrated into the applicator 1 can be provided so as to create an integrated film application module. In this case, an impression cylinder 4 arranged downstream of a press nip between a blanket or form cylinder 13 and the impression cylinder 4 can be assigned a press roll 3′. Thus, after the coating of the printing material by means of the applicator 1, a film web 5′ of a transfer film can be supplied to the transfer nip 6′ and can also be led away directly again. In this way, the cold film embossing is carried out in a single integrated film application module FA as shown in FIG. 1.

As illustrated schematically in FIG. 1 in connection with the applicator 1, an applicator of complex design can also be arranged within the coating module in an integrated film application module FA. For this purpose, an adhesive application device 1′ is assigned to the impression cylinder 4 and arranged upstream of the transfer nip, which is provided between the rubber-covered cylinder 13 and the impression cylinder 3. With such an arrangement, the transfer film would be led around the rubber-covered cylinder 13 or approximately tangentially past the rubber-covered cylinder through the designated press nip. For this purpose, such an adhesive application device 1′ can comprise a compact form cylinder for carrying a printing form for the adhesive and an application unit comprising a chamber-type doctor and an engraved roll for supplying the adhesive. In this case, again integrated on the same impression cylinder 4, the application of adhesive to the printing material is performed first and, directly following this, the application of the film is carried out.

In the illustrated embodiment, the film supply roll 8 is assigned to the coating unit 2 on the sheet supply side. The film supply roll 8 includes a rotary drive 7 such that the supply of the transfer film to the coating unit 2 can be continuously regulated. Deflection and tensioning rolls can be provided in the film supply in order to guide the transfer film 5 with a substantially constant tension with respect to the press roll 3. On the outlet side of the printing unit, a film collection roller 9 is provided for the used film material. It can be advantageous to also supply the film collection roller 9 with a rotary drive 7. If desired, the transfer film 5 can be conveyed on the outlet side by the rotary drive 7 and kept taut on the supply side by a brake.

The press roll 3 (as a printing blanket or form cylinder or separate press roll) includes a compressible or damping element on its surface. The compressible or damping element can also have a compressible intermediate layer. The press roll 3 can be provided with a press covering for this purpose. For example, the press covering can comprise a plastic cover, comparable with a rubber blanket or printing blanket that is held in clamping devices in a cylinder channel. A compressibility that is advantageous can be produced by using a conventional compressible printing blanket or a combination of coverings comprising a hard printing blanket and a soft underlay.

In order to ensure the economy of the coating method, the feed of the transfer film 5 from the film supply roll 8 to the transfer nip 6 and to the film collecting roll 9 can be controlled in a step-by-step manner with the transfer film 5 being stopped when no transfer of the image-imparting or covering layer is to take place. To this end, an appropriate transfer film feed control system is preferably provided which ensures that at least the part of the film web located in the region of the press roll 3 and the impression cylinder 4 is at a standstill as long as a cylinder channel is passing through.

The utilization of the film can be further improved if the transfer film 5 is subdivided into one or more partial film webs of reduced width. In such a case, given appropriate control with the aid of the device or devices for cycling the film feed of each of the part film webs, the utilization of the transfer film 5 can be improved when coating regions or zones having differing lengths within a sheet.

With the device of the present invention, a printing material can be sealed or laminated on one side and provided with a particularly resistant surface layer. For this purpose, the film transfer device is arranged in a printing or varnishing unit arranged downstream of the printing units of a sheet-fed printing press. With an arrangement of this type, the surface of the fresh print is also protected. For further applications, the first film transfer device can an associated second film transfer device arranged downstream thereof within the sheet-fed rotary printing press so that double lamination of a sheet also becomes possible. Furthermore, the printing press can be configured with a first film application module before the first printing unit transferring an ink or a coating, and for a second film application module after the last ink-transferring printing unit. With such an arrangement, a first lamination or barrier layer can be applied directly to the printing material and a second lamination can be applied over the printed image.

With a device according to the present invention carrying out the cold film embossing method, functional packaging materials can be laminated on one or both sides within a sheet-fed rotary printing press to provide, for example, barrier properties. Through the combination of coating units (such as coating modules), a sheet turning device and film coating modules, film can be applied to one or both sides. With printability of the printing material on both sides, decorative and functional applications and composite film packaging materials can be produced.

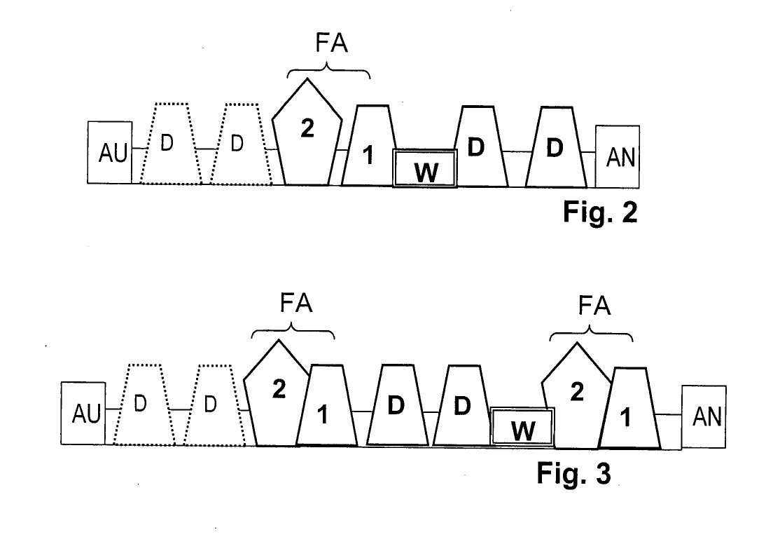

FIGS. 2 and 3 illustrate exemplary sheet-fed printing press configurations according to the invention that are capable of achieving desirable operating modes. In FIGS. 2 and 3, printing units D are provided for the processing of viscous printing inks. If desired, varnishing modules for processing liquid varnishes or coating media can also be employed instead of the printing units D. Printing units D can also be used to apply a coating of liquid coating media.

The printing press illustrated in FIG. 2 has a so-called turning device W after two printing units D or varnishing modules (or a combination of printing units and varnishing modules) following the sheet feeder AN. Turning devices W are used in a sheet-fed printing press to turn over a printing sheet printed or coated on one side so that its other side can then be printed or coated. In the configuration shown in FIG. 2, the turning device W is followed by an applicator 1 and a coating module 2, which can also be arranged as an integrated film application module FA within a printing unit. Further downstream, a plurality of further printing units D can be provided as far as the sheet deliverer AU.

With the printing press configuration illustrated in FIG. 2, each printed sheet can be first printed in one or two colors from its rear side or printed and coated, then turned and coated with a laminating film layer over its entire area and then printed with multiple colors again. One example of an application where such a process could be used is packaging materials that require a protective or barrier layer against the emergence of substances from the packaging material contents. This process also prevents unwanted changes in the printing ink applied to the packaging material.

The printing press illustrated in FIG. 3 has a one-piece or two-part film application module following the sheet feeder AN. Following the sheet feeder AN, the printing press of FIG. 3 has a turning device W that can be used to turn over a printed sheet coated on one side with film material so that its other side can then be printed or coated. In the configuration shown in FIG. 3, the turning device W is followed by an applicator 1 and a coating module 2, which can also be arranged as an integrated film application module FA within a printing unit. Further downstream, a plurality of further printing units D can be provided as far as the sheet deliverer AU.

With the printing press configuration shown in FIG. 3, each printed sheet can be first printed in one or two colors from its rear side, then turned and coated with a laminating film layer over its entire area and then printed again multiple colors. One example of an application where such a process could be used is packaging materials that require a protective or barrier layer against the emergence of substances from the packaging material contents. This process also prevents unwanted changes in the printing ink applied to the packaging material.

With printing machines of this type, there are further processing options in that printed sheets can be provided with optical or tactile patterns, which are laid under the film coating and can be seen or felt through the film coating. Alternatively, optical or textile surface patterns can be applied over the film itself. Such coating operations can be carried out on one side or both sides of unprinted or printed surfaces.

The procedures that can be accomplished with the present invention include, by way of example:
1. Two-sided coating of a printing material by a film application via a cold film embossing method can be used to produce composite packaging materials, such as combinations of paper-aluminum-PET or PET-aluminum-PE or the like.
2. The processing of film and/or paper with vapor-deposited aluminum lamination, vapor-deposited aluminum papers or a barrier protection or the application of a further film layer can be performed using in-line printing or coating using a sheet-fed rotary printing press and a cold film embossing application for the production of composite packaging materials with one or more coating modules within a printing press. Thus, establishing the functional characteristics of the packaging material properties can be combined with the application of a decorative film.
3. In combination with the method steps for in-line printing, the production of composite packaging materials by processing film or paper of different qualities, a barrier protection or the application of a further film layer can be achieved, even after pre-coating, via in-line varnishing and in-line coating within a single sheet-fed rotary printing press having varnishing modules and one or more cold film embossing devices. It is therefore also possible for the establishment of the functional characteristics of the packaging material properties, a visual or tactile pre-coating and the application of a lamination or decorative film to be combined.
4. If appropriate, in the cold film embossing application, integration of the cold film embossing method may be suitable for general application for printing or coating both sides via the combination of printing, sheet turning, film application to the opposite side, (if appropriate) printing and varnishing.
5. The application of functional characteristics substantially increases the value of the packaging material products, in particular, as a result of the introduction of barrier properties with regard to water vapor, blackdamp aroma, smells, light protection, seal strength and barrier layers.

Film can be applied to both sides of the packaging materials in in-line and/or off-line operation in order to improve their barrier properties.

The processing of aluminum-laminated printing materials is a further possibility through a cold film embossing application in a sheet-fed rotary or flexographic printing press.

The device of the present invention can include a coating module for the cold film embossing method before and/or after a turning device within a sheet-fed printing press. Such an arrangement can advantageously supplement the described process technology.

### LIST OF REFERENCE SYMBOLS

1. Applicator
2. Coating unit
3. Press roll
4. Impression cylinder
5. Transfer film/film web
6. Transfer nip
7. Roll drive
8. Film supply roll
9. Film collecting roll
10. Press fabric
11. Winding shaft
12. Plate cylinder
13. Part film roll
14. Unwinding shaft
15. Printing unit guard
16. Rubber-covered roll
17. Outlet opening
18. Dancer roll
D Printing unit
AN Feeder
AU Deliverer
FA Film application module
W Turning device

1. A method for transferring a layer from a carrier film to a printing sheet in a sheet-fed rotary printing press comprising the steps of:
coating a first side of the printing sheet with an adhesive in an applicator unit;
guiding a carrier film through a transfer nip in a first coating unit under pressure together with the printing sheet, the carrier film being arranged along the surface of a press roll with a coated side including a coating layer in contact with the printing sheet such that the coating layer from the carrier film adheres to the adhesive on the first side printing sheet and is thereby transferred to the first side of the printing sheet with the transferred coating layer covering the entire area of the first side of the printing sheet;
turning the printing sheet to a expose a second side of the printing sheet; and
performing a further processing step on the second side of the printing sheet in a second coating unit.

2. The method according to claim 1, wherein the first side of the printing sheet has printing image and the further processing step comprises transferring a coating layer from a second transfer film to the second side of the printings sheet with the transferred coating layer covering the entire area of the second side of the printing sheet.

3. The method according to claim 1, wherein the further processing step comprises printing on the second side of the printing sheet.

4. The method according to claim 1, wherein the further processing step comprises transferring a coating layer from a second transfer film to the second side of the printing sheet with the transferred coating layer covering the entire area of the second side of the printing sheet.

5. The method according to claim 4, wherein the first side of the printing sheet includes a first coating prior to application of the adhesive and the second side of the printing sheet includes a first coating prior to the further processing step and the further processing step comprises transferring a further coating layer from a second transfer film to the second side of the printing sheet with the transferred further coating layer covering the entire area of the second side of the printing sheet.

6. The method according to claim 1, wherein a printing image is applied to the first side of the printing sheet after application of the coating layer from the transfer film and the further processing step comprises transferring a coating layer from a second transfer film to the second side of the printing sheet with the transferred coating layer covering the entire area of the second side of the printing sheet, further comprising the stop of applying a print image to the second side of the printing sheet after application of the coating layer from the second transfer film.

7. The method according to claim 6, wherein the first side of the printing sheet includes a first coating prior to application of the adhesive and the second side of the printing sheet includes a first coating prior to the further processing step and the further processing step comprises transferring a further coating layer from a second transfer film to the second side of the printing sheet with the transferred further coating layer covering the entire area of the second side of the printing sheet.

8. The method according to claim 1, wherein the first side of the printing sheet has a visual or tactile pre-coating and the adhesive is applied over the pre-coating.

9. The method according to claim 8, wherein the pre-coating is carried out via one of a printing unit, a varnishing module or inkjet print heads.

10. The method according to claim 8, wherein the pre-coating is carried out in a further coating unit using one of a letterpress printing process, gravure printing process or planographic printing process.

11. The method according to claim 1 wherein the coating layer of the carrier film includes a visual or tactile pre-coating that is transferred to the first side of the printing sheet with the coating layer of the carrier film.

12. The method according to claim 1 wherein the coating layer transferred to the first side of the printing sheet has optical properties.

13. The method according to claim 1, wherein the coating layer transferred to the first side of the printing sheet is a barrier layer resistant to penetration.

14. The method according to claim 1, wherein the coating layer transferred to the first side of the printing sheet is an optical functional layer.

15. The method according to claim 1, wherein the coating layer transferred to the first side of the printing sheet is a functional layer reflecting radiation.

16. The method according to claim 1, wherein the coating layer transferred to the first side of the printing sheet is a functional layer forming structures.

17. The method according to claim 1, wherein the coating layer transferred to the first side of the printing sheet is a functional layer increasing the strength of the printing material.

18. A sheet fed rotary printing press for processing a printed sheet comprising:
a sheet feeder;
a sheet deliverer;
a plurality of working units arranged between the sheet feeder and the sheet deliverer;
a sheet turning device for turning over the printed sheet arranged between two of the working units;
a first of the working units comprising a film application module including an applicator unit for applying an adhesive to a first side of a printing sheet and a coating unit for transferring the layer from the transfer film to the printing sheet, the coating unit including a transfer nip and a press roll, the transfer film being guidable under pressure through the transfer nip while touching the press roll together with the printing sheet with the adhesive coated first side of the printing sheet in contact with the layer on the transfer film such that the layer is transferred from the transfer film to the printing sheet.

19. The printing press according to claim 18, wherein the working units include a varnishing module or printing unit and a plurality of printing units and the working units and turning device are arranged as follows in a sheet transport direction between the sheet feeder and the sheet deliverer:
a) the film application module;
b) the turning device;
c) the varnishing module or printing unit; and
d) the plurality of printing units.

20. The device according to claim 18, wherein the working units include a varnishing module or printing unit and a plurality of printing units and the working units and turning device are arranged as follows in a sheet transport direction between the sheet feeder and the sheet deliverer:
a) the varnishing module or printing unit;
b) the film application module;
c) the turning device;
d) the plurality of printing units.

21. The device according to claim 18, wherein the working units include a first set of a plurality of printing units and a second set of a plurality of printing units and the working units and turning device are arranged as follows in a sheet transport direction between the sheet feeder and the sheet deliverer:
a) the first set of a plurality of printing units;
b) the film application module;
c) the turning device;
d) the second set of a printing units;
e) the film application module.

22. The device according to claim 18, wherein the working units include a first varnishing module or printing unit, a second varnishing module or printing unit, a first set of a plurality of printing units and a second set of a plurality of working units and the working units and turning device are arranged as follows in a sheet transport direction between the sheet feeder and the sheet deliverer:
a) the first varnishing module or printing unit,
b) the film application module;
c) the first set of a plurality of printing units;
d) the turning device;
e) the second varnishing module or printing unit;
f) the film application module;
g) the second set of a plurality of printing units.

23. The device according to claim 18, wherein the working units include a first set of a plurality of printing units and a second set of a plurality of printing units and the working units and turning device are arranged as follows in a sheet transport direction between the sheet feeder and the sheet deliverer:
a) the film application module;
b) the first set of a plurality of printing units;
c) the turning device;
d) the second set of a plurality of printing units.

24. The device according to claim 18, wherein the film application module is a first film application module, the working units include a second film application module, a varnishing module or printing unit and a plurality of printing units and the working units and turning device are arranged as follows in a sheet transport direction between the sheet feeder and the sheet deliverer:
a) the varnishing module or printing unit;
b) the first film application module;
c) the turning device;
d) the plurality of printing units;
e) the second film application module.

25. The device according to claim 18, wherein the film application module is a first film application module, the working units include a second film application module, a third film application module, a varnishing module or printing unit and a plurality of printing units and the working units and turning device are arranged as follows in a sheet transport direction between the sheet feeder and the sheet deliverer:
a) the varnishing module or printing unit;
b) the first film application module;
c) the turning device;
d) the second film application module;
e) the plurality of printing units;
f) the third film application module.
